(19) United States
(12) Patent Application Publication
(10) Pub. No.: US 2007/0126682 A1
(43) Pub. Date: Jun. 7, 2007

(54) Liquid crystal display with shared gate lines and driving method for same

(75) Inventors: Chang-Jun Liu, Shenzhen (CN); Yi-Yin Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,276

(22) Filed: Dec. 4, 2006

(30) Foreign Application Priority Data
Dec. 2, 2005 (TW) 94142476

(51) Int. Cl. G09G 3/36

(52) U.S. Cl. 345/92

(57) ABSTRACT

An exemplary liquid crystal display includes a plurality of gate lines (201) and a plurality of data lines (202) insulated from and crossing with each other defining a plurality of display regions, each one of the display region includes a first pixel unit (208), and a second pixel unit (218). The first pixel unit includes a P-type thin film transistor (203) having a gate (2031), and the second pixel unit includes an N-type thin film transistor (213) having a gate (2131). The gates of the P-type and N-type thin film transistors are both connected to a same one of the gate line.

### FIELD OF THE INVENTION

The present invention relates to liquid crystal displays, and more particularly to a liquid crystal display wherein two adjacent pixel units are driven by a shared gate line.

### GENERAL BACKGROUND

Liquid crystal displays (LCDs) generally have advantages of lightness in weight, a thin profile, flexible sizing, and low power consumption. For these reasons, LCDs are widely used in products such as laptops, personal digital assistants, mobile phones, and so on.

A conventional LCD generally includes two substrates, and a liquid crystal layer between the two substrates. One of the substrates has a matrix of pixel electrodes corresponding to a matrix of pixels of the LCD. The other substrate has a common electrode. The matrix of pixel electrodes and corresponding portions of the common electrode are cooperatively defined as a matrix of pixel units. The matrix of pixel units typically includes a multiplicity of pixel units, which may be as many as several million or more. Any exemplary portion of the matrix of pixel units is referred to herein and shown in the drawings as a ‘pixel unit array’.

Referring to FIG. 4, a pixel unit array 100 of a conventional liquid crystal display is illustrated. The pixel unit array 100 includes a plurality of gate lines 101 and a plurality of data lines 102. The gate and data lines 101, 102 are insulated from and perpendicularly cross each other, thereby defining a plurality of pixel units 110. Each pixel unit 110 includes an N-type thin film transistor 103, a pixel electrode 106, a common electrode 107, and a storage capacitor 105.

The pixel electrode 106 and the common electrode 107 define a liquid crystal capacitor 104, which is connected in parallel with the storage capacitor 105. The thin film transistor 103 includes a gate 1031, a source 1032, and a drain 1033, which are connected to the gate line 101, the data line 102, and the pixel electrode 106 respectively.

Each gate line 101 transfers a gate voltage provided by a scanning driving circuit (not shown) for all the pixel units 110 arranged in any one row of the pixel units 110. Each data line 102 transfers a source voltage provided by a source driving circuit (not shown) for all the pixel units 110 arranged in any one column of the pixel units 110.

Referring also to FIG. 5, this shows driving waveforms and voltage waveforms of the pixel electrode 106 of an exemplary pixel unit 110. Vg represents the gate voltage transferred by the gate line 101, Vs represents the source voltage transferred by the data line 102, and Vp represents the voltage of the pixel electrode 106.

When the pixel unit array 100 is operating, the gate 1031 is enabled by a positive gate voltage which is generated by the scanning driving circuit applied on the gate line 101, thereby allowing the source 1032 to connect to the drain 1033. Thus the source voltage generated by the source driving circuit applied on the data line 102 begins to charge the pixel electrode 106. The variation of the voltage of the pixel electrode 106 modifies the electric field of the liquid crystal capacitor 104. Therefore liquid crystal molecules in the liquid crystal layer in the pixel unit 110 alter their orientations. This alters the characteristics of light transmission through the pixel unit 110. In this way, all the pixel units 110 of the liquid crystal display cooperate to provide an image that is displayed on a screen of the liquid crystal display.

When the display resolution of the liquid crystal display is high, the number of pixel units 110 needed is correspondingly high. Accordingly, the number of gate and data lines 101, 102 may be very great—as many as several million or more. In such cases, the structure of the matrix of pixel units 110 of the liquid crystal display is correspondingly complicated. In addition, the gate and data lines 101, 102 are typically made of opaque metallic material. Therefore the gate and data lines 101, 102 generally reduce the so-called ‘aperture ratio’ of each of the pixel units 110.

Accordingly, what is needed is a liquid crystal display configured to overcome the above-described problems.

### SUMMARY

An exemplary liquid crystal display includes a plurality of gate lines, a plurality of data lines. The data lines are insulated from and cross with the gate lines, and the data lines and gate lines cooperatively define a plurality of display regions. The display region includes a first pixel unit and a second pixel unit. The first pixel unit includes a P-type thin film transistor and a first pixel electrode, and the P-type thin film transistor includes a gate, a source, and a drain. The second pixel unit includes an N-type thin film transistor and a second pixel electrode, and the N-type thin film transistor includes a gate, a source, and a drain. The gates of the P-type and N-type thin film transistors are both connected to a same one of the gate line. The source of the P-type and N-type thin film transistors are connected to a corresponding one of data lines. The drain of the P-type thin film transistor is connected to the first pixel unit, and the drain of the N-type thin film transistor is connected to the second pixel unit.

A detailed description of embodiments of the present invention is given below with reference to the accompanying drawings.

### BRIEF DESCRIPTION OF THE DRAWINGS

In the drawings, all the views are schematic.

FIG. 1 is a top plan view of a pixel unit array of a liquid crystal display in accordance with a first embodiment of the present invention.

FIG. 2 is an enlarged view of adjacent exemplary first and second pixel units of the pixel unit array of FIG. 1.

FIG. 3 is a three-part graph of voltage (V) versus time (t), showing driving waveforms and voltage waveforms of first and second pixel electrodes of the first and second pixel units of FIG. 2.

FIG. 4 is a top plan view of a pixel unit array of a conventional liquid crystal display.

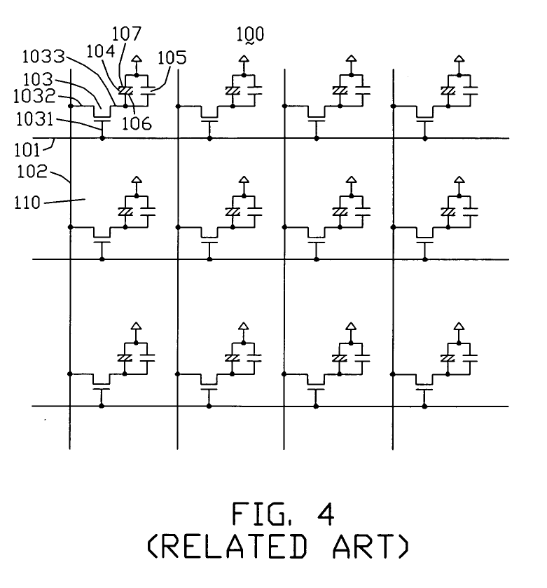

FIG. 5 is a two-part graph of voltage (V) versus time (t), showing driving waveforms and voltages of a pixel electrode of an exemplary pixel unit of the pixel unit array of FIG. 4.

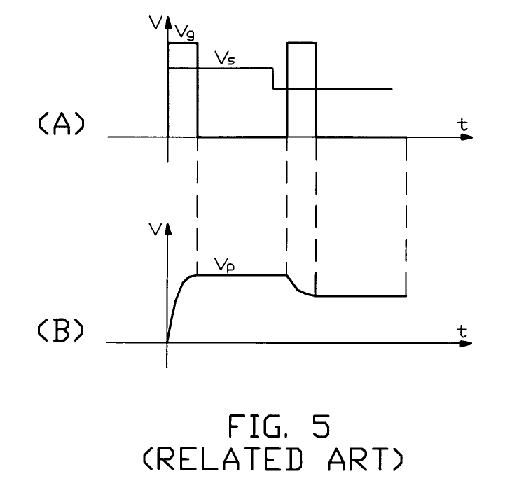

### DETAILED DESCRIPTION OF PREFERRED EMBODIMENTS

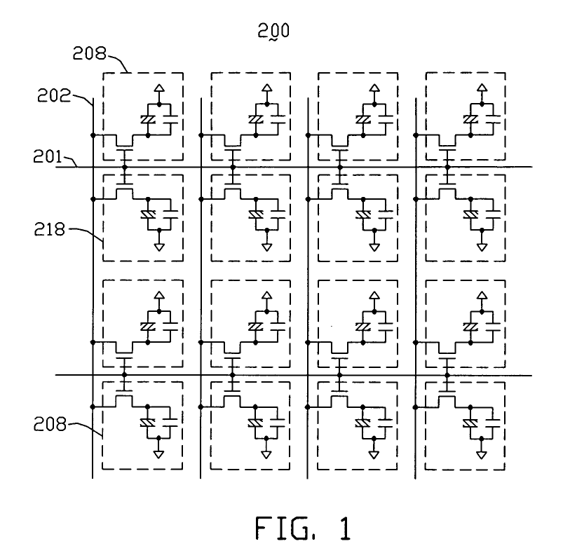

Referring to FIG. 1, this shows a pixel unit array 200 of an exemplary liquid crystal display. The pixel unit array 200 is similar in certain respects to the above-described conventional pixel unit array 100. However, there are also important differences. The pixel unit array 200 includes a plurality of gate lines 201 and a plurality of data lines 202. The gate and data lines 201, 202 are insulated from and cross each other, and cooperatively define a plurality of display regions (not labeled). Each display region includes a first pixel unit 208 and a second pixel unit 218.

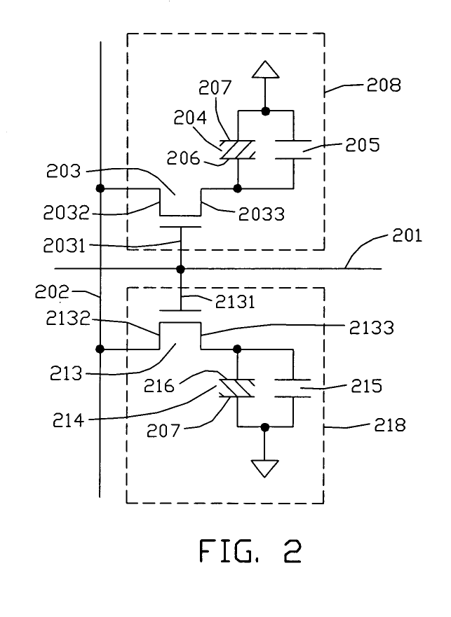

Referring also to FIG. 2, this is an enlarged view of the first pixel unit 208 and the second pixel unit 218 of any exemplary display region of the pixel unit array 200. The first and second pixel units 208, 218 are connected to a same one of the gate lines 201.

The first pixel unit 208 includes a P-type thin film transistor 203, a first storage capacitor 205, a first pixel electrode 206, and a common electrode 207. A first liquid crystal capacitor 204 is defined by the first pixel electrode 206 and the common electrode 207. The first liquid crystal capacitor 204 is connected in parallel with the second storage capacitor 205. The thin film transistor 203 includes a gate 2031, a source 2032, and a drain 2033. The gate 2031 is connected to the gate line 201, the source 2032 is connected to the corresponding data line 202, and the drain 2033 is connected to the first pixel electrode 206.

The second pixel unit 218 includes an N-type thin film transistor 213, a second storage capacitor 215, a second pixel electrode 216, and the common electrode 207. A second liquid crystal capacitor 214 is defined by the second pixel electrode 216 and the common electrode 207. The second liquid crystal capacitor 214 is connected in parallel with the second storage capacitor 215. The thin film transistor 213 includes a gate 2131, a source 2132, and a drain 2133. The gate 2131 is connected to the gate line 201, the source 2132 is connected to the data line 202, and the drain 2133 is connected to the second pixel electrode 216.

The gate line 201 transfers a gate voltage provided by a scanning driving circuit (not shown) of the liquid crystal display to the gates 2013, 2131 of the thin film transistors 203, 213 respectively. The data line 202 transfers a source voltage provided by a source driving circuit (not shown) of the liquid crystal display for the sources 2032, 2132 of the thin film transistors 203, 213 respectively.

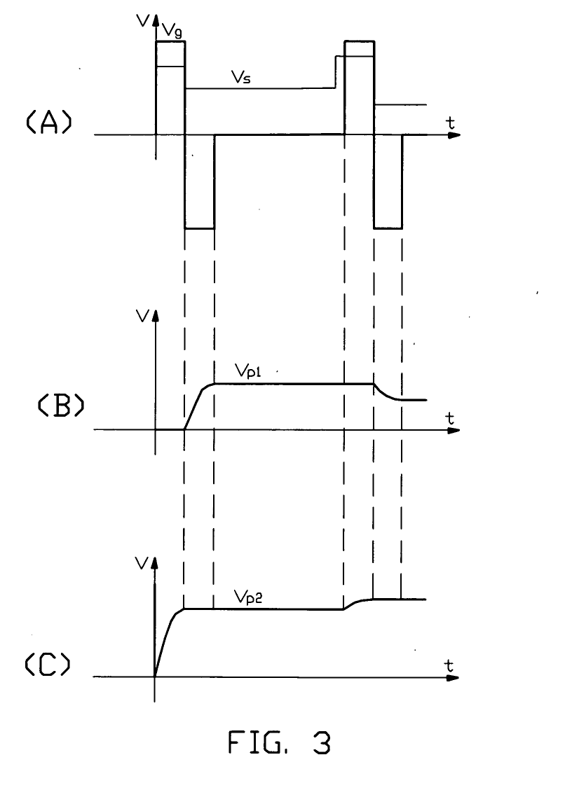

Referring to FIG. 3, this shows driving waveforms and voltage waveforms of the first and second pixel electrodes 206, 216 of the display region. Vg represents the gate voltage transferred by the gate line 201, Vs represents the source voltage transferred by the data line 202, and Vp1 and Vp2 represent the voltage of the first and second pixel electrodes 206, 216 respectively. The gate voltage includes a positive gate voltage, a ground gate voltage, and negative gate voltage.

When the pixel unit array 200 operates, three conditions according to the positive, ground, and negative gate voltages are described as follows.

When a positive gate voltage Vg generated by the scanning driving circuit is applied on the gate line 201, this enables the gate 2131 of the second thin film transistor 213, and thereby allows the source 2132 to connect to the drain 2133. A source voltage generated by the source driving circuit applied on the data line 202 begins to charge the second pixel electrode 216 through the drain 2133. At the same time, the gate 2031 of the first thin film transistor 203 is disabled, and thereby the source 2032 is disconnected from the drain 2033.

When a negative gate voltage Vg generated by the scanning driving circuit is applied on the gate line 201, this enables the gate 2031 of the first thin film transistor 203, and thereby allows the source 2032 to connect to the drain 2033. A source voltage generated by the source driving circuit applied on the data line 202 begins to charge the first pixel electrode 206 through the drain 2033. At the same time, the gate 2131 of the second thin film transistor 213 is disabled, and thereby the source 2132 is disconnected from the drain 2133.

When a ground gate voltage Vg generated by the scanning driving circuit is applied on the gate line 201, the gates 2031, 2131 of the first and second thin film transistors 203, 213 are both disabled. Therefore the drains 2033, 2133 of the first and second thin film transistors 203, 213 are both disconnected from the data line 202. The negative and positive gate voltages Vg applied to the first and second pixel electrodes 206, 216 respectively are maintained by the storage capacitors 205, 215 respectively.

In summary, the first and second pixel units 208, 218 in each display region are controlled by a same one of the gate lines 201. Therefore the number of gate lines 201 needed for the liquid crystal display is reduced. The means that the structure of the liquid crystal display is simplified. In addition, the aperture ratio of each of the first and second pixel units 208, 218 can be increased.

While preferred and exemplary embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
a plurality of gate lines; and
a plurality of data lines insulated from and crossing the gate lines such that the gate lines and data lines cooperatively define a plurality of display regions, each of the display regions comprising a first pixel unit and a second pixel unit, the first pixel unit comprising a P-type thin film transistor and a first pixel electrode, the P-type thin film transistor comprising a gate, a source, and a drain, the second pixel unit comprising an N-type thin film transistor and a second pixel electrode, the N-type thin film transistor comprising a gate, a source, and a drain;
wherein the gate of the P-type thin film transistor and the gate of the N-type thin film transistor are connected to a same one of the gate lines, the source of the P-type thin film transistor is connected to a corresponding one of the data lines, the source of the N-type thin film transistor is connected to the corresponding data line, the drain of the P-type thin film transistor is connected to the first pixel electrode, and the drain of the N-type thin film transistor is connected to the second pixel electrode.

2. The liquid crystal display as claimed in claim 1, further comprising a common electrode, wherein the first pixel electrode of the first pixel unit and the common electrode define a liquid crystal capacitor.

3. The liquid crystal display as claimed in claim 2, wherein the first pixel unit further comprises a storage capacitor, and the storage capacitor is connected in parallel with the liquid crystal capacitor.

4. The liquid crystal display as claimed in claim 1, further comprising a common electrode, wherein the second pixel electrode of the second pixel unit and the common electrode define a liquid crystal capacitor.

5. The liquid crystal display as claimed in claim 4, wherein the second pixel unit further comprises a storage capacitor, and the storage capacitor is connected in parallel with the liquid crystal capacitor.

6. A driving method for a liquid crystal display, comprising:
providing a plurality of gate lines of the liquid crystal display;
providing a plurality of data lines of the liquid crystal display, the data lines being insulated from and crossing the gate lines;
defining a plurality of first pixel units of the liquid crystal display according to a matrix formed by the crossing gate lines and data lines, each of the first pixel units comprising a P-type thin film transistor and a first pixel electrode, the P-type thin film transistor comprising a gate, a source, and a drain, the gate being connected to a corresponding one of the gate lines, the source being connected to a corresponding one of the data lines, and the drain being connected to the first pixel electrode;
defining a plurality of second pixel units according to the matrix, the second pixel units being adjacent the first pixel units respectively, each of the second pixel units comprising an N-type thin film transistor and a second pixel electrode, the N-type thin film transistor comprising a gate, a source, and a drain, the gate being connected to the corresponding gate line, the source being connected to the corresponding data line, and the drain being connected to the second pixel electrode;
providing a source voltage on the data line;
providing a positive voltage on the gate line, thereby enabling the gate of the N-type thin film transistor and charging the first pixel electrode with the source voltage;
providing a negative voltage on the gate line, thereby enabling the gate of the P-type thin film transistor and charging the second pixel electrode with the source voltage; and
providing a ground voltage on the gate line, thereby disabling the gate of the N-type thin film transistor and the gate of the P-type film transistor.

7. A liquid crystal display comprising:
a plurality of gate lines; and
a plurality of data lines insulated from and crossing the gate lines such that the gate lines and data lines cooperatively define a plurality of display regions, each of the display regions comprising a first pixel unit and a second pixel unit, the first pixel unit comprising a P-type thin film transistor and a first pixel electrode, the P-type thin film transistor comprising a gate, a source, and a drain, the second pixel unit comprising an N-type thin film transistor and a second pixel electrode, the N-type thin film transistor comprising a gate, a source, and a drain;
wherein the first pixel unit and the second pixel unit of the same display region share the same data line and the same gate line.

8. The liquid crystal display as claimed in claim 7, wherein said first pixel unit and said second pixel unit of the same display region have a same connection point to the get line.

9. The liquid crystal display as claimed in claim 8, wherein said first pixel unit and said second pixel unit essentially arranged in a mirror image with each other with regard to the shared gate line.
